(19) United States
(12) Patent Application Publication
(10) Pub. No.: US 2020/0349727 A1
(43) Pub. Date: Nov. 5, 2020

(54) OBSTACLE DETECTION METHOD, MOBILE PLATFORM, AND COMPUTER READABLE STORAGE MEDIUM

(71) Applicant: SZ DJI TECHNOLOGY CO., LTD., Shenzhen (CN)

(72) Inventors: Ang LIU, Shenzhen (CN); Litian ZHANG, Shenzhen (CN); Lu MA, Shenzhen (CN)

(21) Appl. No.: 16/935,790

(22) Filed: Jul. 22, 2020

Related U.S. Application Data
(63) Continuation of application No. PCT/CN2018/073861, filed on Jan. 23, 2018.

(51) Int. Cl. G06T 7/50; G06T 7/73; B64C 39/02; G01S 17/894

(52) U.S. Cl. CPC G06T 7/50; G06T 7/73; G06T 2207/30261; G01S 17/894; G06T 2207/10028; B64C 39/024

(57) ABSTRACT

The present disclosure provides an obstacle detection method. The method includes acquiring a first type of grid including obstacle indication information; determining a corresponding project position of the first type of grid in a first depth image; acquiring a first distance between a mobile platform and the corresponding projection position and a second distance between the mobile platform and an obstacle, the obstacle being the obstacle detected based on the first depth image; and updating the obstacle indication information of the first type of grid based on the first distance and the second distance.

### CROSS-REFERENCE TO RELATED APPLICATION

This application is a continuation of International Application No. PCT/CN2018/073861, filed on Jan. 23, 2018, the entire content of which is incorporated herein by reference.

### TECHNICAL FIELD

The present disclosure relates to the field of electronic information technology and, more specifically, to an obstacle detection method, a mobile platform, and a computer readable storage medium.

### BACKGROUND

Unmanned vehicles such as unmanned aerial vehicles (UAVs) have been developed for various fields, including consumer applications and industrial applications. For example, UAVs can be used for entertainment, photography/filming, surveillance, delivery, or other applications. UAVs have expanded all aspects of daily activities.

As the use of UAVs become more common, the functions of the UAVs have increased. For example, the mapping function is a widespread application of the UAVs. The purpose of mapping is to output the surrounding obstacle map for UAV navigation such that the UAV can plan a path based on the map to avoid obstacles and reach the destination.

However, the mapping methods in conventional technology are generally time-consuming and the user experience is often poor.

### SUMMARY

One aspect of the present disclosure provides an obstacle detection method. The method includes acquiring a first type of grid including obstacle indication information; determining a corresponding project position of the first type of grid in a first depth image; acquiring a first distance between a mobile platform and the corresponding projection position and a second distance between the mobile platform and an obstacle, the obstacle being the obstacle detected based on the first depth image; and updating the obstacle indication information of the first type of grid based on the first distance and the second distance.

Another aspect of the present disclosure provides a mobile platform. The mobile platform includes a processor; and a memory storing one or more sets of instruction sets that, when executed by the processor, causes the processor to: acquire a first type of grid including obstacle indication information; determine a corresponding project position of the first type of grid in a first depth image; acquire a first distance between a mobile platform and the corresponding projection position and a second distance between the mobile platform and an obstacle, the obstacle is the obstacle detected based on the first depth image; and update the obstacle indication information of the first type of grid based on the first distance and the second distance.

### BRIEF DESCRIPTION OF THE DRAWINGS

In order to illustrate the technical solutions in accordance with the embodiments of the present disclosure more clearly, the accompanying drawings to be used for describing the embodiments are introduced briefly in the following. It is apparent that the accompanying drawings in the following description are only some embodiments of the present disclosure. Persons of ordinary skill in the art can obtain other accompanying drawings in accordance with the accompanying drawings without any creative efforts.

FIG. 1 is a diagram of a structure of an UAV according to an embodiment of the present disclosure.

FIG. 2 is a flowchart of an obstacle detection method according to an embodiment of the present disclosure.

FIGS. 3A-3C are top views of a grid of a three-dimensional space in a navigation coordinate system on a certain horizontal plane according to an embodiment of the present disclosure.

FIG. 4 is a flowchart of another obstacle detection method according to an embodiment of the present disclosure.

FIGS. 5A-5B are top views of a grid of a three-dimensional space in a navigation coordinate system on a certain horizontal plane according to an embodiment of the present disclosure.

FIG. 6 is a structural block diagram of a mobile platform according to an embodiment of the present disclosure.

### DETAILED DESCRIPTION OF THE EMBODIMENTS

Technical solutions of the present disclosure will be described in detail with reference to the drawings. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure. In the situation where the technical solutions described in the embodiments are not conflicting, they can be combined.

The terms used in the following descriptions are only for the purpose of describing specific embodiments, and are not intended to limit the scope of the present disclosure. In addition, the singular forms “a,” “an,” and “the” are intended to include the plural forms as well, unless the context indicates otherwise. It should be understood that the term “and/or” used herein includes any suitable combination of one or more related items listed.

It can be appreciated that, while the terms “first,” “second,” “third” and so on may be used herein to describe various information, such information is not limited to these terms, which are only used to distinguish between different information of the same category. For example, the first information can also be referred to as the second information, and similarly the second information can also be referred to as the first information, without departing from the scope of the present disclosure. Depending on the context, the term “if” as used herein can be interpreted as “when,” “while,” or “in response to determining.”

An embodiment of the present disclosure provides an obstacle detection method, which can be applied to a mobile platform. The mobile platform may include at least a robot, an unmanned aerial vehicle, and an unmanned vehicle.

The obstacle detection method may be used to achieve simultaneous positioning and map construction. More specifically, the mobile platform may start from an unknown location in an unknown environment, and locate its positon and attitude through repeated observation of map features (e.g., corners, pillars, etc.) during movement. Subsequently, based on positon and attitude of the mobile platform, a map may be built incrementally, thereby achieving the purpose of simultaneous positioning and map construction.

For the ease of description, take the UAV as the mobile platform as an example, the UAV can include a binocular camera, or a time-of-flight (TOF) camera. The UAV can acquire depth images through the binocular camera or the TOF camera, and perform obstacle detection based on the depth images. When the mobile platform is a robot or an unmanned vehicle, the processing process is similar to that of a UAV, therefore, it will not be repeated herein.

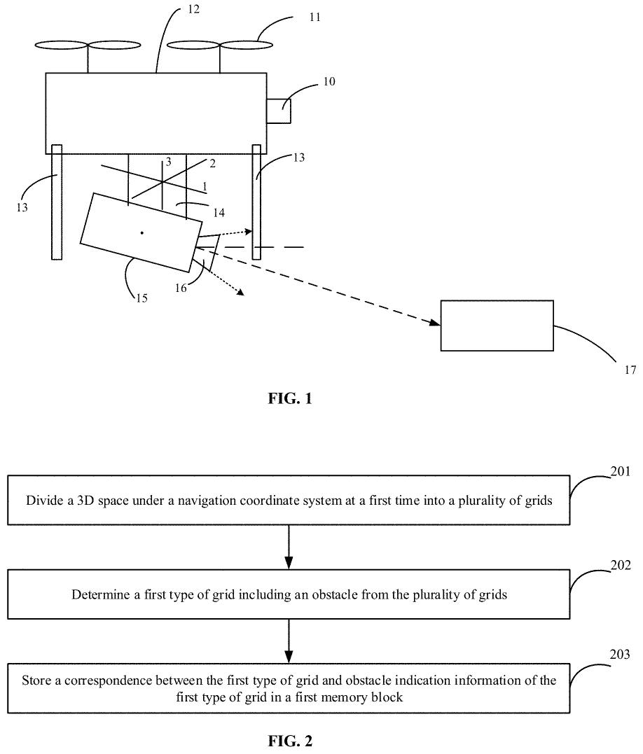

FIG. 1 is a diagram of a structure of an UAV according to an embodiment of the present disclosure. The UVA includes a nose 10, a rotor 11, a body 12, a landing gear 13, a gimbal 14, an imaging device 15 being carried on the gimbal 14, an imaging lens 16 of the imaging device, and a target object 17. The imaging device 15 is connected to the body 12 of the UAV through the gimbal 14.

The gimbal 14 can be a three-axis gimbal, that is, the gimbal 14 may rotate around the roll axis, pitch axis, and yaw axis of the gimbal. As shown in FIG. 1, the roll axis of the gimbal is represented by reference numeral 1, the pitch axis of the gimbal is represented by reference numeral 2, and the yaw axis of the gimbal is represented by reference numeral 3. When the gimbal rotates on the roll axis, the roll angle of the gimbal changes; when the gimbal rotates on the pitch axis, the pitch angle of the gimbal changes; and when the gimbal rotates on the yaw axis, the yaw angle of the gimbal changes. In addition, when the gimbal rotates around one or more of the roll axis, pitch axis, and yaw axis, the imaging device 15 can rotate following the direction of the gimbal 14. As such, the imaging device 15 can acquire image of the target object 17 from different imaging directions and angles.

Similar to the gimbal 14, the body 12 of the UAV can also rotate around the roll axis, pitch axis, and yaw axis of the body. When the body of the UAV rotates around the roll axis, the roll angle of the body changes; when the body of the UAV rotates around the pitch axis, the pitch angle of the body changes; and when the body of the UAV rotates around the yaw axis, the yaw angle of the body changes.

The above description briefly introduces the structure of the UAV. In order to detect obstacles around the UAV, the UAV can acquire a depth image through a binocular camera or a TOF camera, and identify the target object 17 as an obstacle around the UAV based on the depth image. It can be understood that since the UAV can identify the target object as an obstacle, there may be no obstacle in the area between the UAV and the target object 17.

Based on the above application scenario, FIG. 2 is a flowchart of an obstacle detection method according to an embodiment of the present disclosure. The method can be applied to a mobile platform. The method will be described in detail below.

201, dividing a three-dimensional (3D) space under a navigation coordinate system at a first time into a plurality of grids.

In some embodiments, the 3D space under the navigation coordinate system (e.g., the takeoff point of the UAV may be the origin, the north direction may be the positive X-axis direction, and the east direction may be the positive Y-axis direction. Of course, other directions can also be used to construct the navigation coordinate system, which is not limited in the present disclosure) can be divided into a plurality of grids. The method for dividing the navigation coordinate system is not limited in the present disclosure. Each grid may have a unique position of the grid under the navigation coordinate system, and the size of the grid may be adjusted. In some embodiments, the size of all grids may be the same. In other embodiments, the size of different grids may be different. For example, the grid closer to the current position of the UAV may be smaller, and the grid farther away from the current position of the UAV may be larger.

In some embodiments, the grid resolution may be used to represent the size of the grid, and the grid resolution may refer to the number of grids in a unit space. More specifically, the closer the grid to the current positon of the UAV, the smaller the grid, the higher the resolution of the grid, and the greater the number of grids in the unit space may be. The farther the grid to the current position of the UAV, the larger the grid, the lower the resolution of the grid, and the less the number of grids in the unit space may be.

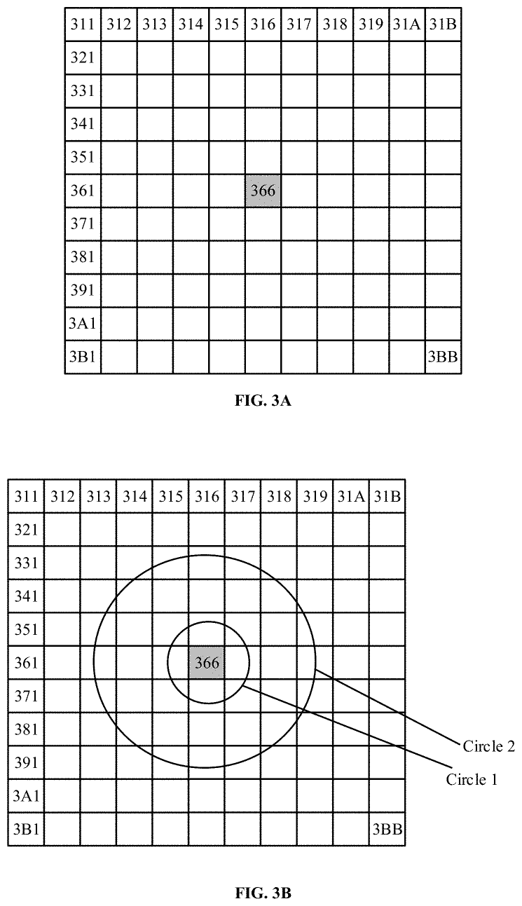

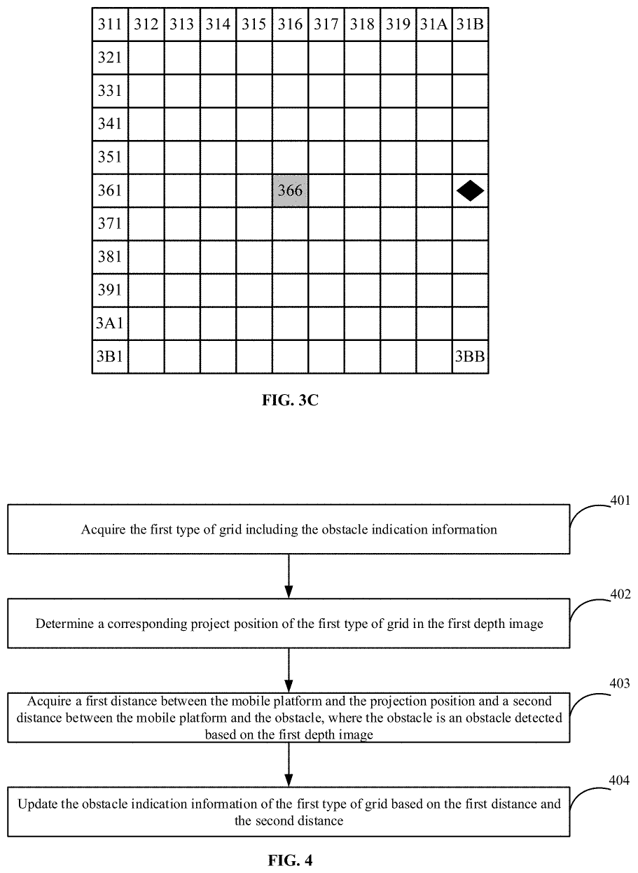

Referring to FIG. 3A, which is a top view of a grid divided by a 3D space in the navigation coordinate system at the first time on a certain horizontal plane. The first time may include grids 311-31B, grids 321-32B, grids 3B1-3BB, and so on. In FIG. 3A, the mobile platform is located in grid 366.

In some embodiments, when the 3D space under the navigation coordinate system is divided into a plurality of grids, the resolution of all grids may be the same. Alternatively, a corresponding resolution for each grid may be set based on the distance between each grid and the mobile platform. In addition, when setting the corresponding resolution for each grid, the shorter the distance between the grid and the mobile platform, the higher the resolution corresponding to the grid may be; and the longer the distance between the grid and the mobile platform, the lower the resolution corresponding to the grid may be.

For example, referring to FIG. 3B. The resolution of each grid included in Circle 1 may be resolution A, the resolution of the each grid included in Circle 2 may be resolution B, and the resolution of each grid not included in the Circle 2 may be resolution C. In addition, resolution A may be higher than resolution B, and resolution B may be higher than resolution C.

In some embodiments, based on the distance between each grid and the mobile platform, setting the corresponding resolution for each grid may include the following methods. In a first method, if the distance between the grid and the mobile platform is less than a third threshold, a first resolution may be set for the grid; and, if the distance between the grid and the mobile platform is greater than or equal to the third threshold, a second resolution may be set for the grid, where the first resolution may be higher than the second resolution. In a second method, if the distance between the grid and the mobile platform is less than a fourth threshold, a third resolution may be set for the grid; if distance between the grid and the mobile platform is greater than a fifth threshold, a fourth resolution may be set for the grid; and, if the distance between the grid and the mobile platform is greater than or equal to the fourth threshold and less than or equal to the fifth threshold, a fifth resolution may be set for the grid, where the fourth threshold may be less than the fifth threshold, the third resolution may be greater than the fifth resolution, and the fifth resolution may be greater than the fourth resolution.

In the first method, the third threshold can be set based on experience, which is not limited in the present disclosure. For example, in FIG. 3B, the third threshold is the length of three grids.

In the second method, the fourth threshold and the fifth threshold can be set based on experience, which is not limited in the present disclosure, as long as the fourth threshold is less than the fifth threshold. For example, in FIG. 3B, the fourth threshold is the length of a grid, and the fifth threshold is the length of three grids.

Therefore, when the resolution is set for each grid in the above manner, the map-building range and the map update speed can be decoupled. That is, when the range of the map is increased, it has little effect on the update speed of the map, and the accuracy of the map can be dynamically adjusted. That is, the map of places near the mobile platform may have higher accuracy, which allows the mobile platform to perform a more detailed path planning, whereas the map of places far away from the mobile platform may have lower accuracy, which can speed up the update of the map, thus taking into account the needs of wide range of map construction and high accuracy.

202, determining a first type of grid including an obstacle from the plurality of grids.

As shown in FIG. 3C, assuming there is an obstacle in the grid 36B, the mobile platform can determine the grid 36B includes an obstacle from the plurality of grids, and the grid 36 is the first type of grid.

In some embodiments, determining the first type of grid including the obstacle from the plurality of grids may include acquiring a second depth image (for the convenience of distinction, the depth image at the first time may be referred to as the second depth image) at the first time and converting the second depth image into a first 3D point cloud; determining the grid corresponding to each feature point in the first 3D point cloud, and determining the first type of grid including the obstacle based on the feature point information of each grid. Of course, the method described above is merely one method for determining the first type of grid including the obstacle, and other methods can also be used to determine the first type of grid including the obstacle, which is not limited in the present disclosure.

In some embodiments, the mobile platform can acquire the second depth image (also referred to as a distance image) at the first time through the binocular camera or the TOF camera, which is not limited in the present disclosure. The second depth image may refer to the image that takes the distance (depth) from the mobile platform to each point in the scene as the pixel value, which can directly reflect the geometry of the visible surface of the scene, and the depth image can be calculated as point cloud data after a coordinate conversion.

In some embodiments, after the mobile platform acquires the second depth image, the second depth image can be converted into the first 3D point cloud (the point cloud corresponding to the second depth image may be referred to as the first 3D point cloud), and the conversion process is not limited in the present disclosure. Subsequently, a grid corresponding to each feature point in the first 3D point cloud may be determined. Referring to FIG. 3C, since there is an obstacle in the grid 36B, each feature point in the first 3D point cloud may be the feature point corresponding to the obstacle. As such, the grid corresponding to the feature points in the first 3D point cloud may be the grid 36B.

Further, since the grid 36B includes multiple feature points in the first 3D point cloud, other grids other than the grid 3B may not include feature points in the first 3D point cloud. Therefore, based on the feature point information of each grid (e.g., the number of feature points in the grid), the first type of grid including obstacle can be determined to be the grid 36B.

203, storing a correspondence between the first type of grid and obstacle indication information of the first type of grid in a first memory block. In some embodiments, for the convenience of distinction, a memory block used to store the correspondence between the first type of grid and the obstacle indication information of the first type of grid may be referred to as a first memory block.

In some embodiments, after determining the first type of grid including the obstacle, a free memory block may be selected from the buffer, and the correspondence between the first type of grid and the obstacle indication information of the first type of grid may be stored in the memory block.

For example, the buffer may include memory block 1 to memory block 10. After determining the grid 36B including the obstacle, a free memory block 1 can be selected, and the correspondence between the grid 36B and the obstacle indication information of the grid 36B may be stored in the memory block 1. After determining the grid 371 including the obstacle, a free memory block 2 (memory block already has content, therefore, is no longer a free memory block) can be selected, and the correspondence between the grid 371 and the obstacle indication information of the grid 371 may be stored in the memory block 2.

In some embodiments, the obstacle indication information of the first type of grid may be a predetermined mark, such as a mark a, and mark 1 may indicate the presence of obstacles in the first type of grid. In addition, the obstacle indication information of the first type of grid may also be the probability of the presence of obstacles, such as 90%, and the 90% may indicate that the probability of the presence of obstacles in the first type of grid is 90%.

The process of determining the first type of grid including the obstacle based on the feature point information of each grid (such as the number of feature points in the grid) has been described in detail above. Therefore, if the obstacle indication information is a predetermined mark, the correspondence between the first type of grid and the predetermined mark may be stored in the first memory block. If the obstacle indication information is the probability of the presence of obstacles, the probability of the presence of obstacles can also be determined based on the number of feature points in the first type of grid. For example, the greater the number of feature points, the higher the probability of the presence of obstacles. Subsequently, the correspondence between the first type of grid and the probability of the presence of obstacles may be stored in the first memory block.

For example, when the distance between the first type of grid and the mobile platform is less than a certain threshold, the first memory block may be divided into 16*16*16 memory units. The 16*16*16 memory units may correspond to 16*16*16 areas of the first type of grid, and each memory unit may store the obstacle indication information in the corresponding area. In addition, when the distance between the first type of grid and the mobile platform is greater than the threshold, the first memory block may be divided into 2*2*2 memory units. The 2*2*2 memory units may correspond to 2*2*2 areas of the first type of grid, and each memory unit may store the obstacle indication information of the corresponding area. The memory block can be divided into different number of memory units, which is not limited in the present disclosure.

Therefore, when dividing the memory block into multiple memory units in the above manner, the map-building range and the map update speed can be decoupled. That is, when the range of the map is increased, it has little effect on the update speed of the map, and the accuracy of the map can be dynamically adjusted. That is, the map of places near the mobile platform may have higher accuracy, which allows the mobile platform to perform a more detailed path planning, whereas the map of places far away from the mobile platform may have lower accuracy, which can speed up the update of the map, thus taking into account the needs of wide range of map construction and high accuracy.

In some embodiments, a first grid storage unit at the first time may be acquired. The first grid storage unit may include a plurality of sub-grid storage units corresponding to each grid at the first time. The address information of the first memory block (for storing the correspondence between the first type of grid and the obstacle indication information of the first type of grid) corresponding to the first type of grid may be stored in the sub-grid storage units corresponding to the first type of grid.

In some embodiments, the grid storage unit (for the convenience of distinction, the grid storage unit at the first time may be referred to as the first grid storage unit) can be divided in the buffer. The storage buffer unit may be different from the memory block above described above, that is the memory block and the grid storage unit may be different storage units. In addition, the first grid storage unit may include a plurality of sub-grid storage units, and the number of the sub-grid storage units may be the same as the number of grids at the first time.

Referring to FIG. 3A, there are 121 grids at the first time. Therefore, the first grid storage unit may include 121 sub-grid storage units. The first sub-grid storage unit may be used to store the information of the grid 311, the second sub-grid storage unit may be used to store the information of the grid 312, and so on.

For each grid not including the obstacle, e.g., the grid 311, since the grid 311 is not the first type of grid including the obstacle, the first sub-grid storage unit may be used to store the position information (e.g., position coordinates) of the grid 311, the distance information between the grid 311 and the mobile platform, the identification information of the grid 311, etc.

In some embodiments, when storing the correspondence between the first type of grid and the obstacle indication information of the first type of grid in the first memory block, the first memory block can also be divided into multiple memory units (e.g., a cell), and each memory unit may correspond to an area of the first type of grid. The number of memory units into which each memory block is divided may be the same. Alternatively, the number of memory units into which each memory block is divided may be determined based on the distance between the first type of grid and the mobile platform. For example, when the distance between the first type of grid and the mobile platform is less than a certain threshold, the number of memory units included in the first memory block may be a first predetermined number; and when the distance between the first type of grid and the mobile platform is greater than the threshold, the number of memory units included in the first memory block may be a second predetermined number. In some embodiments, the first predetermined number may be greater than the second predetermined number.

For the first type of grid including the obstacle, e.g., the grid 36B, a sub-grid storage unit 66 can be used to store the positon information of the grid 36B, the distance information of the grid 36B and the may be configured to, the identification information of the grid 36B, etc. In addition, the address information of the first memory block (e.g., the first memory block where the correspondence between in the grid 36B and the obstacle indication information of the grid 36B may be stored).

In summary, by corresponding the sub-grid storage unit for each grid at the first time, it is possible to quick acquire which grid may be the first type of grid including the obstacle, and acquire the obstacle indication information corresponding to the first type of grid from the memory block. For example, by querying the 121 sub-grid storage units of the first grid storage unit at the first time, it can be determined that the grid 36B stored in the sub-grid storage unit 66 includes an obstacle, and the grids stored in other sub-grid storage units do not have obstacles, therefore, the grid 36B may be determined as the first type of grid including the obstacle. Subsequently, the address information of the first memory block may be acquired from the sub-grid storage unit 66, and the obstacle indication information corresponding to the grid 36B may be acquired from the first memory block based on the address information of the first memory block. As such, the obstacle indication information may be quickly acquired.

FIG. 4 is a flowchart of another obstacle detection method according to an embodiment of the present disclosure. The method can be applied to a mobile platform. The method will be described in detail below.

401, acquiring the first type of grid including the obstacle indication information.

In some embodiments, acquiring the first type of grid including the obstacle indication information may include acquiring the first type of grid including the obstacle indication information from the first memory block.

Referring to the embodiment described above. At the first time, the correspondence between the first type of grid and the obstacle indication information of the first type of grid has been stored in the first memory block. Based on this, at a second time after the first time, the first type of grid including the obstacle indication information may be acquired from the first memory block.

402, determining a corresponding project position of the first type of grid in the first depth image.

In some embodiments, determining the corresponding project position of the first type of grid in the first depth image may include acquiring the first depth image at the second time (after the first time), and determining the corresponding project position of the first type of grid in the first depth image based on the position information of the first type of grid.

In some embodiments, the mobile platform can acquire the first depth image (also referred to as a distance image) at the second time through the binocular camera or the TOF camera, which is not limited in the present disclosure. The first depth image may refer to the image that takes the distance (depth) from the mobile platform to each point in the scene as the pixel value, which can directly reflect the geometry of the visible surface of the scene, and the depth image can be calculated as point cloud data after a coordinate conversion

Since the sub-grid storage unit can be used to store the position information (e.g., position coordinates) of the grid, the distance information between the grid and the mobile platform, the identification information of the grid, etc., the mobile platform may acquire the position information of the first type of grid from the sub-grid storage unit. Based on the position information of the first type of grid, the projection position of the first type of grid in the first depth image may be determined, that is, the corresponding positon of the first type of grid in the first depth image may be determined. In particular, the method for determining the projection position is not limited in the present disclosure.

403, acquiring a first distance between the mobile platform and the projection position, and a second distance between the mobile platform and the obstacle, where the obstacle may be an obstacle detected based on the first depth image.

In some embodiments, since the position of the mobile platform is known and the projection position is known, the first distance between the mobile platform and the projection position can be directly acquired.

In some embodiments, acquiring the second distance between the mobile platform and the obstacle may include acquiring the first depth image at the second time and converting the first depth image into a second 3D point cloud. Subsequently, the position of the obstacle at the second time may be determined based on the second 3D point cloud, and the second distance between the mobile platform and the position of the obstacle may be determined.

The method for acquiring the first depth image has been described above, and will not be repeated here. After acquiring the first depth image, the first depth image can be converted into a second 3D point cloud (the point cloud corresponding to the first depth image may be referred to as the second 3D point cloud). The conversion process is not limited in the present disclosure. Subsequently, the position of the obstacle at the second time may be determined based on the second 3D point cloud. For example, the feature point of the second 3D point cloud may be the feature point corresponding to the obstacle. As such, the position of the feature point in the second 3D point cloud may be the position of the obstacle at the second time. Since the position of the mobile platform is known and the position of the obstacle is known, the second distance between the mobile platform and the position of the obstacle can be directly acquired. In particular, the method for acquiring the second distance is not limited in the present disclosure.

In some embodiments, the 3D space under the navigation coordinate system at the second time can be divided into a plurality of grids. The method for dividing the navigation coordinate system is not limited in the present disclosure. Each grid may have a unique position of the grid under the navigation coordinate system, and the size of the grid may be adjusted. In some embodiments, the size of all grids may be the same. In other embodiments, the size of different grids may be different. For example, the grid closer to the current position of the UAV may be smaller, and the grid farther away from the current position of the UAV may be larger. The second type of grid corresponding to the position of the obstacle at the second time may be determined, and the correspondence between the second type of grid and the obstacle indication information of the second type of grid may be stored in the second memory block.

In some embodiments, when the 3D space under the navigation coordinate system at the second time is divided into a plurality of grids, the resolution of all grids may be the same. Alternatively, the mobile platform may also set a corresponding resolution for each grid based on the distance between each grid and the mobile platform. In addition, when setting the corresponding resolution for each grid, the shorter the distance between the grid and the mobile platform, the higher the resolution corresponding to the grid may be; and the longer the distance between the grid and the mobile platform, the lower the resolution corresponding to the grid may be. In some embodiments, the grid resolution may be used to represent the size of the grid, and the grid resolution may refer to the number of grids in a unit space. More specifically, the closer the grid to the current positon of the UAV, the smaller the grid, the higher the resolution of the grid, and the greater the number of grids in the unit space may be. The farther the grid to the current position of the UAV, the larger the grid, the lower the resolution of the grid, and the less the number of grids in the unit space may be.

In some embodiments, determining the second type of grid corresponding to the position of the obstacle at the second time may include, after converting the first depth image into the second 3D point cloud, determining the grid corresponding to each feature point in the second 3D point cloud at the second time, and determining the second type of grid including the obstacle based on the feature point information of each grid.

In some embodiments, after determining the second type of grid including the obstacle, the correspondence between the second type of grid and the obstacle indication information of the second type of grid may be stored in the second memory block. For the convenience of distinction, the memory block used to store the correspondence between the second type of grid and the obstacle indication information of the second type of grid may be referred to as the second memory block. More specifically, a plurality of memory blocks can be divided in the buffer. After determining the second type of grid including the obstacle, a free memory block may be selected from the buffer, and the correspondence between the second type of grid and the obstacle indication information of the second type of grid may be stored in the memory block.

In some embodiments, the obstacle indication information of the second type of grid may be a predetermined mark, such as a mark 1, and mark 1 may indicate the presence of obstacles in the second type of grid. In addition, the obstacle indication information of the first type of grid may also be the probability of the presence of obstacles, such as 90%, and the 90% may indicate that the probability of the presence of obstacles in the second type of grid is 90%.

In some embodiments, when storing the correspondence between the second type of grid and the obstacle indication information of the second type of grid in the second memory block, the second memory block can also be divided into multiple memory units (e.g., a cell), and each memory unit may correspond to an area of the second type of grid. The number of memory units into which each memory block is divided may be the same. Alternatively, the number of memory units into which second memory block is divided may be determined based on the distance between the second type of grid and the mobile platform. For example, when the distance between the second type of grid and the mobile platform is less than a certain threshold, the number of memory units included in the second memory block may be a third predetermined number; and when the distance between the second type of grid and the mobile platform is greater than the threshold, the number of memory units included in the second memory block may be a fourth predetermined number. In some embodiments, the third predetermined number may be greater than the fourth predetermined number.

404, updating the obstacle indication information of the first type of grid based on the first distance and the second distance.

In some embodiments, updating the obstacle indication information of the first type of grid based on the first distance and the second distance may include determining there is no obstacle in the first type of grid in response to the difference between the first distance and the second distance being greater than the firs threshold, and updating the obstacle indication information based on a determination result of the absence of obstacles. Further, updating the obstacle indication information of the first type of grid based on the first distance and the second distance may further include determined that there is an obstacle in the first type of grid in response to the difference between the first distance and the second distance being less than or equal to the first threshold, and updating the obstacle indication information based on the determination result of the presence of obstacles.

If the obstacle indication information is a predetermined mark, updating the obstacle indication information based on the determination result of the absence of obstacles may include updating the obstacle indication information to a mark 0, and mark 0 may indicate that there is no obstacle in the first type of grid. Further, updating the obstacle indication information based on the determination result of the presence of obstacles may include maintaining the obstacle indication information as mark 1, and mark 1 may indicate the presence of obstacles in the first type of grid.

If the obstacle indication information is the probability of the presence of obstacles, updating the obstacle indication information based on the determination results of the absence of the obstacles may include reducing the probability of obstacles of the first type of grid, such as reducing the probability of obstacles of the first type of grid to 10%, reducing the probability of obstacles of the first type of grid by 50% (such as from 90% to 40%), etc., which is not limited in the present disclosure. Further, updating the obstacle indication information based on the determination results of the presence of the obstacles may include increasing the probability of the presence of obstacles of the first type of grid, such as increasing the probability of obstacles in the first type of grid to 95%, increasing the probability of obstacles of the first type of grid by 10% (such as from 90% to 100%), etc., which is not limited in the present disclosure.

After reducing the probability of the presence of obstacles of the first type of grid, when the reduced probability of the presence of obstacles is less than a second threshold (such as 50%), the memory block (i.e., the first memory block described above) for storing the first type of grid and the probability of the presence of obstacles in the first type of grid can also be released. As such, the first memory block may be a free memory block. In addition, the sub-grid storage unit corresponding to the first type of grid in the first grid storage unit can also be determined, and the address information of the first memory block corresponding to the first type of grid may be deleted from the sub-grid storage unit. Further, after updating the obstacle indication information to the mark 0, the first memory block may also be released, and the address information of the first memory block may be deleted from the sub-grid storage unit.

In some embodiments, a second grid storage unit at the second time may be acquired. The second grid storage unit may include a plurality of sub-grid storage units corresponding to each grid at the second time. The address information of the second memory block (for storing the correspondence between the second type of grid and the obstacle indication information of the second type of grid) corresponding to the second type of grid may be stored in the sub-grid storage units corresponding to the second type of grid.

In some embodiments, the grid storage unit (for the convenience of distinction, the grid storage unit at the second time may be referred to as the second grid storage unit) can be divided in the buffer. The storage buffer unit may be different from the memory block above described above, that is the memory block and the grid storage unit may be different storage units. In addition, the second grid storage unit may include a plurality of sub-grid storage units, and the number of the sub-grid storage units may be the same as the number of grids at the second time.

In some embodiments, a third type of grid may exist at the first time and may not exist at the second, and a fourth type of grid that may not exist at the first time and exist at the second time may be determined. Subsequently, the corresponding sub-grid storage unit of the third type of grid in the first grid storage unit may be recovered, and the recovered sub-grid storage unit may be assigned to the fourth type of grid.

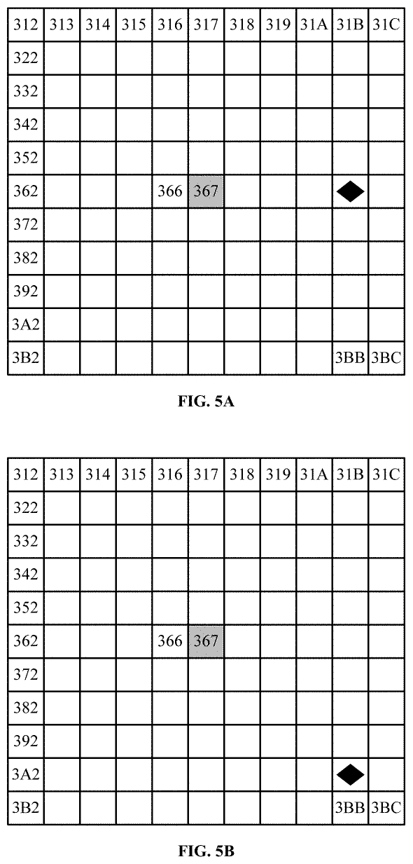

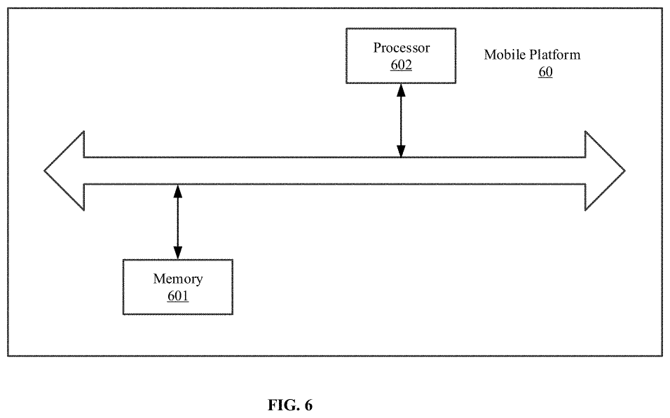

For example, a top view of the grid at a certain horizontal plane at the second time may be as shown in FIG. 5A, in which the mobile platform has moved from grid 366 to grid 369, while the obstacle has not moved, still staying on grid 36B. The first column of grids (such as grid 311, grid 312, etc.) at the first time (as shown in FIG. 3A) is no longer present at the second time, and there is an extra column of grids (such as grid 31C, grid 32C, etc.) at the second time. In summary, the fourth type of grid that may not exist at the first time and exist at the second time may include the last column of grids (such as grid 31C, grid 32C, etc.) at the second time. As such, the sub-grid storage unit 1 corresponding to grid 311 may be recovered and assigned to grid 31C, the sub-grid storage unit 12 corresponding to grid 321 may be recovered and assigned to grid 32C, and so on.

In some embodiments, the second grid storage unit at the second time may include 121 sub-grid storage units. For the first ten columns of the grids in FIG. 5A, the corresponding sub-grid storage units are the same as the sub-grid storage units at the first time, and will not be described here again. For the last column of the grids in FIG. 5A, the sub-grid storage unit 1 is used to store the information of grid 31C (such as position information, distance information between the grid and the mobile platform, grid identification information, etc.), the sub-grid storage unit 12 is used to store the information of grid 32C, and so on.

As such, when the mobile platform continues to move in one direction, the map in front of the mobile platform may continue to expand (i.e., new grids are added, as shown in the last column of grids in FIG. 5A), and the map behind the mobile platform may continue to shrink (e.g., existing grids are reduced, as shown in the first column of FIG. 3A). Compared with the existing grid storage unit (e.g., the first grid storage unit), the new grid storage unit (e.g., the second grid storage unit) may recover the sub-grid storage units corresponding to the first column of the grid storage units. In the second grid storage unit, the recovered sub-grid storage units may be reassigned to the last column of grids, while the middle part of the sub-grid storage units may not need to be changed. That is, the maps corresponding to these sub-grid storage units may not need to be changed, such that the map may be dynamic in an index manner.

By comparing FIG. 5A and FIG. 3A, for the first column of grids in FIG. 3A, since these grids do not exist at the second time, there is no need to re-determine whether there are obstacles in these grids. For the last column of grids in FIG. 5A, at the second time, it can be determined whether there are obstacles in these grids. The specific determination method has been described above and will not be repeated here. For the grid 36B having an obstacle at the first time, 401-404 can be used to re-determine whether there is an obstacle at the second time. In columns 1 to 10 in FIG. 5A, for grids other than grid 36B, there is no need to re-determine whether there are obstacle in these grids at the second time, rather, the determination result at the first time may be used, that is, there are no obstacles. That is, in the second grid storage unit, the sub-grid storage units corresponding to these grids have not changed. Therefore, at the second time, the sub-grid storage units may be directly used to determine that the grids do not have obstacles.

For example, a top view of the grids at a certain horizontal plane at the second time may be as shown in FIG. 5B. The mobile platform moves from grid 366 to grid 367, and the obstacle moves from grid 36B to grid 3AB. The first column of grids (such as grid 311, grid 321, etc.) that exist at the first time (such as shown in FIG. 3A) does not exist at the second time, and there is an extra column of grids (such as grid 31C, grid 32C, etc.) at the second time.

By comparing FIG. 5B and FIG. 3A, for the first column of grids in FIG. 3A, since these grids do not exist at the second time, there is no need to re-determine whether there are obstacles in these grids. For the last column of grids in FIG. 5B, at the second time, it can be determined whether there are obstacles in these grids. The specific determination method has been described above and will not be repeated here. For the grid 36B including an obstacle at the first time, 401-404 can be used to re-determine whether there is an obstacle at the second time. For the grid 3AB including an obstacle at the second time (i.e., the second type of grid described above), at the second time, it can be determined whether there are obstacles in the grid 3AB. The specific determination method has been described above and will not be repeated here.

In columns 1 to 10 in FIG. 5B, for grids other than grid 36B and grid 3AB, there is no need to re-determine whether there are obstacle in these grids at the second time, rather, the determination result at the first time may be used, that is, there are no obstacles in these grids. That is, in the second grid storage unit, the sub-grid storage units corresponding to these grids have not changed. Therefore, at the second time, the sub-grid storage units corresponding to these grids may be directly used to determine that the grids do not have obstacles.

In the conventional technology, at the second time, it is necessary to re-determine whether all grids (such as columns 1 to 11 in FIG. 5A or FIG. 5B) have obstacles, and determine whether there are obstacles in each grid. Therefore, it takes a long time to build the map, the update speed of the obstacles is slow, and the efficiency is low. In the embodiments of the present disclosure, at the second time, it is not necessary to re-determine whether there are obstacles in most grids (such as columns 1 to 10 and grids other than grid 36B and grid 3AB in FIG. 5B, or columns 1 to 10 and grids other than grid 36B in FIG. 5A). Therefore, compared with conventional technology, the embodiment of the present disclosure provides an efficient method for building maps, which can reduce the map construction time and improve the user experience. In addition, the obstacle update speed is faster and the efficiency is higher.

In the embodiment described above, as shown in FIG. 5A, the corresponding projection position of grid 36B (i.e., the first type of grid) in the first depth image may be the position of the grid 36B in the first depth image. The position of the obstacle determined based on the first depth image may be the position of the obstacle in the first depth image. Since the obstacle has not moved, the obstacle may still be in grid 36B. Therefore, the first distance between the mobile platform and the projection position may be the same as the second distance between the mobile platform and the obstacle. That is, the difference between the first distance and the second distance may be less than the first threshold, and the obstacle may still be in grid 36B.

In the embodiment described above, as shown in FIG. 5B, the corresponding projection position of grid 36B (i.e., the first type of grid) in the first depth image may be the position of the grid 36B in the first depth image. The position of the obstacle determined based on the first depth image may be the position of the obstacle in the first depth image. Since the obstacle has move, that is, the obstacle has moved from grid 36B to grid 3AB, as such, the first distance between the mobile platform and the projection position (the position corresponding to grid 36B) may be different from the second distance between the mobile platform and the obstacle (the position corresponding to grid 3AB). That is, the difference between the first distance and the second distance may be greater than the first threshold, therefore, there may be no obstacle in the grid 36B.

In the embodiment described above, if no obstacle is detected at the second time, the second distance between the mobile platform and the obstacle may be determined as a predetermined value, and the difference between the first distance and the second distance may be greater than the first threshold. In some embodiments, the predetermined value can be set based on experience, such as a high value.

In some embodiments, as shown in FIG. 5B, after the obstacle moves from grid 36B to grid 3AB, grid 3AB may be the second type of grid described above, and the correspondence between grid 3AB and the obstacle indication information of grid 3AB may be stored in the second memory block. In addition, the position information of grid 3AB, the distance information between the grid 3AB and the mobile platform, the identification information of the grid 3AB, etc. may be stored in the sub-grid storage unit corresponding to grid 3AB. Further, the address information of the second memory block may be stored in the sub-grid storage unit. The grids other than the grid 3AB may have no obstacles, therefore, the sub-grid storage unit may store the position information of the grid, the distance between the grid and the mobile platform, and the identification information of the grid.

In the embodiment described above, a 3D map may be constructed based on the obstacle information stored in the grid storage unit (e.g., the first grid storage unit and the second grid storage unit described above) and the memory block (e.g., the first memory block and the second memory block described above). The method for constructing the 3D map is not limited in the present disclosure.

At a third time after the second time, the data at the second time may be used as the data at the first time. For the processing flow at the third time, reference may be made to the processing flow at the second time, which will not be repeated here.

Based on the same concept as the method described above, an embodiment of the present disclosure further provides a mobile platform 60. Referring to FIG. 6, the mobile platform 60 includes a memory 601 and a processor 602 (such as one or more processors).

In some embodiments, the memory is used to store program codes, and the processor may be configured to call the program codes. When the program code is executed, the processor 602 may acquire the first type of grid including the obstacle indication information; determine the corresponding projection position of the first type of grid in the first depth image; acquire the first distance between the mobile platform and the projection position, and the second distance between the mobile platform and the obstacle; and update the obstacle indication information of the first type of grid based on the first distance and the second distance, where the obstacle may be an obstacle detected based on the first depth image.

In some embodiments, before the processor 602 acquires the first type of grid including the obstacle indication information, the processor 602 may be configured to divide the 3D space under the navigation coordinate system at the first time into a plurality of grids, and determine the first type of grid including the obstacle from the plurality of grids.

In some embodiments, after the processor 602 determines the first type of grid including the obstacle from the plurality of grids, the processor 602 may be configured to store the correspondence between the first type of grid and the obstacle indication information of the first type of grid in the first memory block. When the processor 602 acquires the first type of grid including the obstacle indication information, the processor 602 may be configured to acquire the first type of grid including the obstacle indication information from the first memory block.

In some embodiments, the processor 602 may be further configured to divide the first memory block into a plurality of memory units, each memory units may correspond to an area of the first type of grid. In addition, the number of memory units included in the first memory block may be determined based on the distance between the first type of grid and the mobile platform.

In some embodiments, when the processor 602 determines the first type of grid including the obstacle from the plurality of grids, the processor 602 may be configured to acquire the second depth image at the first time and convert the second depth image into the first 3D point cloud; determine the grid corresponding to each feature point in the first 3D point cloud; and determine the first type of grid including the obstacle based on the feature point information of each grid.

In some embodiments, when the processor 602 determines the corresponding projection position of the first type of grid in the first depth image, the processor 602 may be configured to acquire the first depth image at the second time, and determine the corresponding projection position of the first type of grid in the first depth image based on the position information of the first type of grid.

In some embodiments, when the processor 602 acquires the second distance between the mobile platform and the obstacle, the processor 602 may be configured to acquire the first depth image at the second time and convert the first depth image into a second 3D point cloud; determine the position of the obstacle at the second time based on the second 3D point cloud; and acquire the second distance between the mobile platform and the position of the obstacle.

In some embodiments, after the processor 602 determines the position of the obstacle at the second time based on the second 3D point cloud, the processor 602 may be configured to divide the 3D space under the navigation coordinate system at the second time into a plurality of grids; determine the second type of grid corresponding to the position of the obstacle from the plurality of grids; and store the correspondence between the second type of grid and the obstacle indication information of the second type of grid in the second memory block.

In some embodiments, the processor 602 may be configured to divide the second memory block into multiple memory units, each memory units may correspond to an area of the first type of grid. In addition, the number of memory units included in the second memory block may be determined based on the distance between the second type of grid and the mobile platform.

In some embodiments, when the processor 602 updates the obstacle indication information of the first type of grid based on the first distance and the second distance, the processor 602 may be configured to determine the absence of obstacles in the first type of grid and update the obstacle indication information based on the determination result of the absence of obstacles in response to the difference between the first distance and the second distance exceeding the first threshold.

In some embodiments, the obstacle indication information may include the probability of the presence of the obstacle.

In some embodiments, when the processor 602 updates the obstacle indication information based on the determination result of the absence of obstacles, the processor 602 may be configured to reduce the probability of the presence of obstacles in the first type of grid.

In some embodiments, after the processor 602 reduces the probability of the presence of obstacles in the first type of grid, the processor 602 may be further configured to release the memory block for storing the first type of grid and the presence of obstacles in the first type of grid in response to the reduced probability of the presence of obstacles being less than the second threshold.

In some embodiments, when the processor 602 updates the obstacle indication information of the first type of grid based on the first distance and the second distance, the processor 602 may be configured to determine the presence of obstacles in the first type of grid and update the obstacle indication information based on the determination result of the presence of obstacles in response to the difference between the first distance and the second distance being less than or equal to the first threshold.

In some embodiments, the obstacle indication information may include the probability of the presence of the obstacle.

In some embodiments, when the processor 602 updates the obstacle indication information based on the determination result of the presence of obstacles, the processor 602 may be configured to increase the probability of the presence of obstacles in the first type of grid.

In some embodiments, when the processor 602 divides the 3D space under the navigation coordinate system into a plurality of grids, the processor 602 may be configured to set a corresponding resolution for each grid based on the distance between each grid and the mobile platform.

In some embodiments, when the distance between the grid and the mobile platform is short, the resolution corresponding to the grid may be higher.

In some embodiments, when the processor 602 sets the corresponding resolution for each grid based on the distance between each grid and the mobile platform, the processor 602 may be configured to set a first resolution for the grid in response to the distance between the grid and the mobile platform being less than a third threshold; or set a second resolution set for the grid in response to the distance between the grid and the mobile platform being greater than or equal to the third threshold, where the first resolution may be higher than the second resolution. Alternatively, set a third resolution for the grid in response to the distance between the grid and the mobile platform being less than a fourth threshold; set a fourth resolution for the grid in response to the distance between the grid and the mobile platform being greater than a fifth threshold; or set a fifth resolution for the grid in response to the distance between the grid and the mobile platform being greater than or equal to the fourth threshold and less than or equal to the fifth threshold, where the fourth threshold may be less than the fifth threshold, the third resolution may be higher than the fifth resolution, and the fifth resolution may be higher than the fourth resolution.

In some embodiments, the processor 602 may be further configured to acquire the first grid storage unit at the first time, where the first grid storage includes a multiple sub-grid storage units corresponding to each grid at the first time; and store the address in formation of the first memory block corresponding to the first type of grid in the sub-grid storage unit corresponding to the first type of grid.

In some embodiments, the processor 602 may be further configured to acquire the second grid storage unit at the second time, where the second grid storage includes a multiple sub-grid storage units corresponding to each grid at the second time; and store the address in formation of the second memory block corresponding to the second type of grid in the sub-grid storage unit corresponding to the second type of grid.

In some embodiments, the processor 602 may be further configured to determine the third type of grid that may be present at the first time, but absent at the second time; determine the fourth type of grid that may be absent at the first time and present at the second time; recover the corresponding sub-grid storage unit of the third type of grid in the first grid storage unit; and assign the recovered sub-grid storage unit to the fourth type of grid.

In some embodiments, the mobile platform may include one or more of a robot, a UAV, or an unmanned vehicle.

Based on the same concept as the method described above, an embodiment of the present disclosure further provides a computer-readable storage medium having computer instructions stored thereon. When the computer instructions is executed, the obstacle detection method described above can be realized.

The system, device, module or unit described in the above embodiments may be realized using a computer chip or a physical entity, or a product having certain functions. A typical realization device is a computer. The detailed form of the computer may be a personal computer, a laptop computer, a cellular phone, a camera phone, a smart phone, a personal digital assistant, a multimedia player, a navigation device, an e-mail receiving and transmitting device, a game control console, a tablet computer, a wearable device, or any combination of two or more of these devices.

For the convenience of descriptions, the above devices are described based on functions being divided as various units. When implementing the present disclosure, functions of various units may be realized in one or multiple software programs and/or hardware components.

A person having ordinary skills in the art can appreciate, the present disclosure may be realized as a method, a system, or a computer program product. As such, the present disclosure may be realized using hardware alone, software alone, or a combination of software and hardware. In addition, the present disclosure may be realized as a computer program product implemented in one or more computer-readable storage media (including but not limited to a magnetic disk, a CD-ROM, an optical device, etc.) that store computer-executable program codes or instructions.

The present disclosure is described with reference to the flow charts and/or block diagrams of the disclosed methods, devices (systems), and computer program products. It should be understood that computer program codes or instructions may be used to realize each step and/or block included in the flow chart and/or block diagram, and a combination of the steps and/or blocks in the flow chart and/or the block diagram. Such computer program codes or instructions may be provided to a generic computer, a dedicated computer, an embedded processor, or a processor of a programmable data processing device to generate a machine, such that a device may be produced through the instructions executed by the computer or other processor of a programmable data processing device. The device may be used to realize a specified function of one or more steps in the flow chart and/or one or more blocks in the block diagram.

In addition, the computer program codes or instructions may be stored in a computer-readable storage medium that may guide a computer or other programmable data processing device to operate in a specified manner, such that instructions stored in the computer-readable storage medium generate a product having an instruction device. The instruction device may realize a specific function of one or more steps in the flow chart and/or one or more blocks of the block diagram.

The computer program codes or instructions may be loaded into a computer or other programmable data processing device, such that a series of steps may be executed on the computer or other programmable data processing device to generate a computer-realized process, such that the codes executed by the computer or other programmable data processing device may provide a step for realizing a specific function of one or more steps of the flow chart and/or one or more blocks of the block diagram.

The above described are only embodiments of the present disclosure, and are not intended to limit the scope of the present disclosure. A person having ordinary skills in the art can modify or change the embodiments of the present disclosure. Such modifications, equivalent substitutions, or improvements within the spirit and principle of the present disclosure all fall within the scope of the claims of the present disclosure.

What is claimed is:

1. An obstacle detection method, comprising:
acquiring a first type of grid including obstacle indication information;
determining a corresponding project position of the first type of grid in a first depth image;
acquiring a first distance between a mobile platform and the corresponding projection position and a second distance between the mobile platform and an obstacle, the obstacle being the obstacle detected based on the first depth image; and
updating the obstacle indication information of the first type of grid based on the first distance and the second distance.

2. The method of claim 1, wherein before acquiring the first type of grid including the obstacle indication information further includes:
dividing a three-dimensional (3D) space under a navigation coordinate system at a first time into a plurality of grids; and
determining the first type of grid including the obstacle from the plurality of grids.

3. The method of claim 2, wherein after determining the first type of grid including the obstacle from the plurality of grids further includes:
storing a correspondence between the first type of grid and the obstacle indication information of the first type of grid in a first memory block; and
acquiring the first type of grid including the obstacle indication information includes acquiring the first type of grid including the obstacle indication information from the first memory block.

4. The method of claim 3, further comprising:
dividing the first memory block into a plurality of memory units, each memory unit corresponds to an area of the first type of grid.

5. The method of claim 3, wherein the number of memory units included in the first memory block is determined based on a distance between the first type of grid and the mobile platform.

6. The method of claim 2, wherein determining the first type of grid including the obstacle from the plurality of grids includes:
acquiring a second depth image at the first time and converting the second depth image into a first 3D point cloud;
determining a grid corresponding to each feature point in the first 3D point cloud; and
determining the first type of grid including the obstacle based on feature point information of each grid.

7. The method of claim 1, wherein determining the corresponding projection position of the first type of grid in the first depth image includes:
acquiring the first depth image at a second time; and
determining the corresponding projection position of the first type of grid in the first depth image based on position information of the first type of grid.

8. The method of claim 1, wherein acquiring the second distance between the mobile platform and the obstacle includes:
acquiring the first depth image at the second time and converting the first depth image into a second 3D point cloud;
determining the position of the obstacle at the second time based on the second 3D point cloud; and
acquiring the second distance between the mobile platform and the obstacle.

9. The method of claim 8, wherein after determining the position of the obstacle at the second time based on the second 3D point cloud further includes:
dividing the 3D space under the navigation coordinate system at the second time into a plurality of grids;
determining a second type of grid corresponding to the position of the obstacle from the plurality of grids; and
storing the correspondence between the second type of grid and the obstacle indication information of the second type of grid in a second memory block.

10. The method of claim 9, further comprising:
dividing the second memory block into a plurality of memory units, each memory unit corresponds to an area of the second type of grid.

11. The method of claim 10, wherein the number of memory units included in the second memory block is determined based on a distance between the second type of grid and the mobile platform.

12. The method of claim 1, wherein updating the obstacle indication information of the first type of grid based on the first distance and the second distance includes:
determining the first type of grid does not include the obstacle and updating the obstacle indication information based on a determination result of an absence of the obstacle in response to a difference between the first distance and the second distance being greater than a first threshold.

13. The method of claim 12, wherein:
the obstacle indication information includes a probability of a presence of the obstacle; and
updating the obstacle indication information based on the determination result of the absence of the obstacle includes reducing the probability of the presence of the obstacle of the first type of grid.

14. The method of claim 13, wherein after reducing the probability of the presence of the obstacle in the first type of grid further includes:
releasing a memory block for storing the first type of grid and the probability of the presence of the obstacle in the first type of grid in response to the reduced probability of the presence of the obstacle being less than a second threshold.

15. The method of claim 1, wherein updating the obstacle indication information of the first type of grid based on the first distance and the second distance includes:
determining the first type of grid includes the obstacle and updating the obstacle indication information based on the determination result of the presence of the obstacle in response to the difference between the first distance and the second distance being less than or equal to the first threshold.

16. The method of claim 15, wherein:
the obstacle indication information includes the probability of the presence of the obstacle; and
updating the obstacle indication information based on the determination result of the presence of the obstacle includes increasing the probability of the presence of the obstacle of the first type of grid.

17. The method of claim 2, wherein dividing the 3D space under the navigation coordinate system into a plurality of grids includes:
setting a corresponding resolution for each grid based on the distance between each grid and the mobile platform.

18. The method of claim 17, wherein:
the corresponding resolution is higher when the distance between the grid and the mobile platform is shorter.

19. The method of claim 3, further comprising:
acquiring a first grid storage unit at the first time, the first grid storage unit includes a plurality of sub-grid storage units corresponding each grid at the first time; and
storing address information of the first memory block corresponding to the first type of grid in the sub-grid storage unit corresponding to the first type of grid.

20. A mobile platform, comprising:
a processor; and
a memory storing one or more sets of instruction sets that, when executed by the processor, causes the processor to:
acquire a first type of grid including obstacle indication information;
determine a corresponding project position of the first type of grid in a first depth image;
acquire a first distance between a mobile platform and the corresponding projection position and a second distance between the mobile platform and an obstacle, the obstacle is the obstacle detected based on the first depth image; and
update the obstacle indication information of the first type of grid based on the first distance and the second distance.
